(19) United States
(12) Patent Application Publication
(10) Pub. No.: US 2005/0188031 A1
(43) Pub. Date: Aug. 25, 2005

(54) Methods and apparatuses for increasing the timeliness and accuracy with which electronic mail massages are communicated

(76) Inventor: Thomas Van Zandt, Sunnyvale, CA (US)

Correspondence Address: Thomas Van Zandt, 5255 Stevens Creek Blvd. #299, Santa Clara, CA, 95051, US

(21) Appl. No.: 11/032,603

(22) Filed: Jan. 11, 2005

Related U.S. Application Data
(60) Provisional application No. 60/539,973, filed on Jan. 30, 2004.

(51) Int. Cl. G06F 15/16

(52) U.S. Cl. 709/206

(57) ABSTRACT

An e-mail message system that evaluates each e-mail message address. During evaluation one or more portions of the address are compared to corresponding valid address portions or to portions of other addresses. These address portions include the user name portion, the domain name portion, and the domain name-type extension, which may include a national identifier. The method of comparison and the response to the evaluation are dependent upon the address portion being evaluated and whether the e-mail message is being going to be sent or has been received. If the evaluation indicates that an address may be invalid or in any way incorrect, appropriate action is taken to ensure the e-mail is directed to the intended recipient. Embodiments of the invention not only help to ensure accurate addressing and delivery of e-mail messages, but also reduce web traffic as less erroneously addressed e-mails will be sent and bounced back.

### CLAIM OF PRIORITY

This application is related to, and hereby claims the benefit of provisional application No. 60/539,973, entitled “Methods and Apparatuses for Increasing the Timeliness and Accuracy with which Electronic Mail messages are Communicated” which was filed Jan. 30, 2004.

### FIELD

Embodiments of the invention relate generally to the field of electronic mail (e-mail) messages and more specifically to methods and apparatuses for helping to ensure delivery of e-mail messages to the intended recipient.

### BACKGROUND

E-mail is the transmission of electronically-stored messages over a communications networks. E-mail is probably the most heavily used feature of the internet with hundreds of millions of e-mail messages communicated each day. Such messages can be notes, entered from a keyboard, or other types of electronic files including pictures, executable programs, sounds, videos or any type of binary file. A typical e-mail is composed using a digital processing system and keyboard to enter the message. E-mail systems typically include a text editor for composing e-mail messages. The e-mail is then sent by specifying an address for the intended recipient. A particular e-mail message may be addressed to multiple intended recipients. The sent messages are stored (i.e., in electronic mailboxes) until the recipient accesses them.

The e-mail address uniquely identifies an intended recipient's mailbox on some host on the internet. A typical e-mail address is “username@domainname.com” where the “username” identifies the individual recipient and the “domainname” identifies the machine providing the e-mail services. The domain name may be an e-mail provider (e.g., hotmail.com) or may be an internet service provider (ISP) or the name of a organization that owns the mail server.

The address of the intended recipient must be typed in following very strict rules. If a single character of the syntax is wrong, then the address is incorrect and the e-mail message will not be communicated to the intended recipient.

This requirement for an exact address is beneficial in that it uniquely identifies an intended recipient and helps to ensure that the e-mail message is not delivered to anyone but the intended recipient. However this scheme also has several, as yet unaddressed drawbacks.

If the e-mail message is addressed incorrectly it will not be delivered to the intended recipient. For example, if an originator (sender) of an e-mail message mistypes the domainname (and the domainname as typed does not exist), the e-mail will not be delivered and the sender may receive an “undeliverable” message. This message prompts the sender to check the address for correctness and verify the address as typed. The e-mail message must then be resent with the corrected address. However, the “undeliverable” message may not be sent to the sender for some time, ranging from less than a minute to several hours depending upon the system. Even a short delay may be detrimental if the sender promptly deactivates or leaves the processing system after sending the e-mail.

If the domain name of the address does exist, the e-mail message will be forwarded to the specified domain's mail server. The mail server checks the username portion of the address to verify if such a username actually exists within its system. If the recipient's address does not exist on the indicated mail server the e-mail message will be rejected because there is no one to deliver the message to. So, for example, if the sender misspells the recipient's address then the system will recognize this as a nonexistent address and bounce the e-mail message back. Again the sender will receive an “undeliverable” message sometime after sending the e-mail. In such case it may take even longer for the sender to be notified because the message is transmitted to a recipient's mail server and the determination of non-deliverability is not made until that point.

A potentially more detrimental scenario is where the sender has addressed an e-mail message with an erroneous user name that actually exists. In this case the e-mail will be delivered to the wrong recipient. The sender will not receive a message indicating this error (i.e., unless the actual (erroneous) recipient notifies the sender). This may mean a much greater delay until the sender realizes the message was not communicated as intended and takes corrective action. A still more detrimental scenario is where the sender has an erroneous domain name and a valid user name for the erroneous domain name. In this case the e-mail message will be sent to the wrong recipient, and such actual recipient is at the wrong organization. That is, for example, sending an e-mail message to the wrong company is most often more detrimental than sending an e-mail message to the wrong person at the intended company. Again, in this scenario, an “undeliverable” message will not be automatically generated for the sender. A recipient at an unintended company may have no interest in taking the time to inform the sender of the mistake even if they become aware of it. This means there will be a greater delay until the sender realizes a mistake has occurred and takes corrective action. Moreover, sensitive information may have been delivered to potentially hostile persons. For example, because many competing business have similar domain names, and because many user names are actual names of employees, some of which are quite common, there is a possibility of sensitive information being delivered to a competitor.

On the recipient's side, a recipient may be expecting an e-mail message. The recipient may have no way of verifying with the sender that the e-mail message has been sent. Even if verification is possible, because of the indeterminate time to communicate an e-mail message, the recipient may be waiting to receive an e-mail message that, due to misaddressing, was undeliverable or delivered to the wrong recipient. This wastes the time of the recipient who may be awaiting an e-mail message before taking some desired action.

### BRIEF DESCRIPTION OF THE DRAWINGS

The invention may be best understood by referring to the following description and accompanying drawings that are used to illustrate embodiments of the invention. In the drawings:

FIG. 1 is a process flow diagram illustrating a process in which an address is evaluated in accordance with one embodiment of the present invention;

FIG. 2 is a process flow diagram illustrating a process in which an address is evaluated in accordance with one embodiment of the present invention; and

FIG. 3 is a block diagram illustrating one embodiment of a processing system 300 that may be used to send and receive e-mail messages in accordance with an embodiment of the present invention.

### DETAILED DESCRIPTION

Overview

In accordance with various embodiments of the invention, an e-mail message system is provided that evaluates each e-mail message address (address). For e-mails about to be sent, the evaluation of the address is effected prior to sending the e-mail message to the network. During evaluation one or more portions of the address are compared to corresponding valid address portions or to portions of other addresses.

These address portions include the user name portion, the domain name portion, and the domain name-type extension, which may include a national identifier. Each address portion being evaluated may be compared to valid corresponding portions. The method of comparison and the response to the evaluation are dependent upon the address portion being evaluated and whether the e-mail is going to be sent or has been received as discussed in more detail below. If the evaluation indicates that an address may be invalid or in any way incorrect, the system notifies the sender and requests verification of the address. For one embodiment, the system may indicate which address portion is likely to be erroneous and why. Embodiments of the invention not only help to ensure accurate addressing and delivery of e-mail messages, but also reduce web traffic as fewer erroneously addressed e-mails will be sent and bounced back.

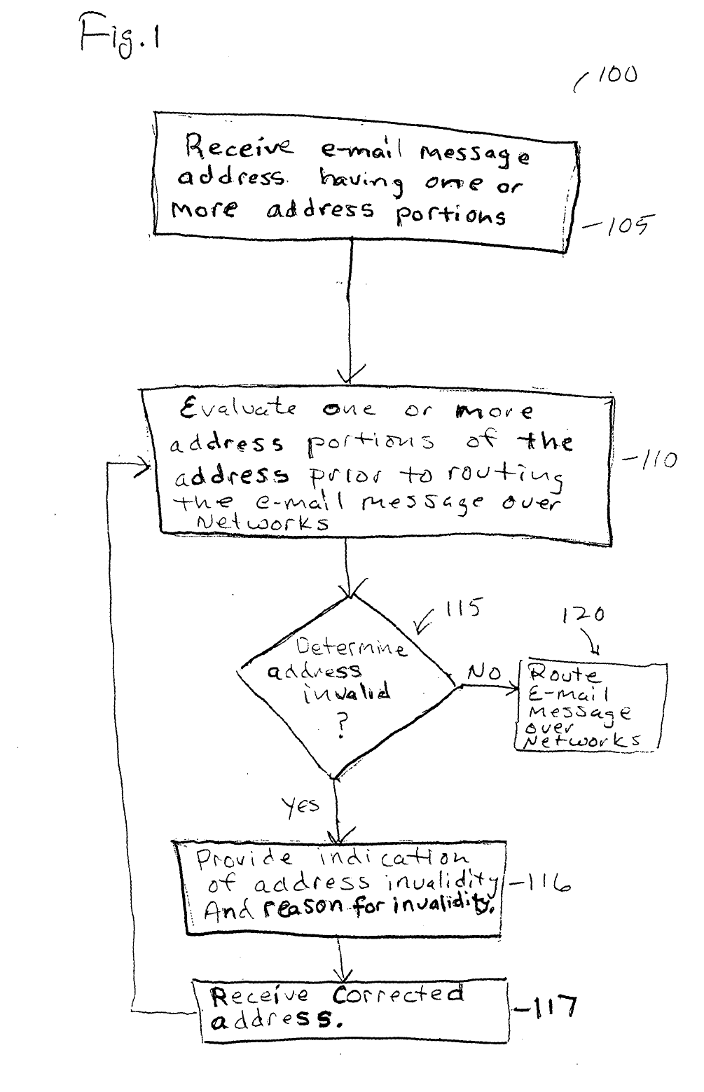

This overview represents some inventive features of various embodiments, which may contain any one of these features alone or in combination. This overview is provided to facilitate the understanding of specific embodiments of the invention discussed below in reference FIGS. 1-3. This overview does not summarize the invention, nor is it intended to be a summary.

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

FIG. 1 is a process flow diagram illustrating a process in which an address is evaluated in accordance with one embodiment of the present invention. Process 100, shown in FIG. 1, begins with operation 105 in which an address is received by an e-mail messaging system in accordance with one embodiment of the invention.

At operation 110 one or more portions of the address are evaluated prior to routing the e-mail message to an internet network. This evaluation process may be effected at the sender's digital processing system or at an internal router of an internal network. The evaluation may take many forms, which may depend upon the address portion being evaluated.

At operation 115, if the evaluation indicates that the one or more address portions evaluated are valid, then, at operation 120, the e-mail message is routed as usual over the networks.

If at operation 11 5, the evaluation indicates that one of the address portions evaluated is not valid, then, at operation 116 an indication of address invalidity is provided. For one embodiment, a reason for invalidity is provided with the indication of invalidity. This allows a sender to quickly realize how (or if) the address has been misspelled and take corrective action.

At operation 117 the corrected address is received and is, itself, evaluated at operation 110 as discussed above. For one embodiment, the sender inputs an override where the indicated erroneous address is actually correct. In such case the e-mail message is routed over the networks despite an invalid address indication.

As noted above in reference to operation 110, the evaluation may take many forms, which may depend upon the address portion being evaluated. If, for example, the domain name-type extension portion is being evaluated, the received domain name-type extension may be compared to a list of stored valid domain name-type extensions. Domain name-type extensions are typically a limited set that may include .com (for commercial organizations), org (for non-profit organizations), and .gov (for governmental organizations), as well national identifiers (e.g., United Kingdom). Because domain name-type extensions are a relatively limited set, the received domain name-type extension address portion can be compared to a stored list of valid domain name-type extensions. If the received domain name-type extension is invalid, the system notifies the sender of the misspelling of the domain-type extension. Since the system stores a list of valid domain name-type extensions, the system can prompt the sender with a possible correction for the erroneous domain name-type extension. For example, where a user inputs “domainname.con” the system would evaluate “con” and realize it is not a valid domain name-type extension. By comparing “con” with the list of valid domain name-type extensions, through a text comparison routine, the system is able to determine that “com” is probably what the sender intended. The sender, then, receives an indication not only of what address portion is suspect, but a probable correction as well. In contrast, prior art systems typically include a “host not found” error after searching for the input domain name. Such host-not-found” messages include the entire domain name, making it difficult to determine where a mistake occurred.

If the domain name portion of the address is evaluated, the system may compare the input domain name with a list of valid domain names (this could be for example a list of domain names to which the sender frequently sends e-mails). If the domain appears on the list, the domain name is considered valid. If the domain does not appear on the list, but has a high correlation to a domain name that does appear on the list, the sender can be prompted to check the spelling of the input domain name. For example, if a sender frequently sends e-mails to encyclopedia.com, which is on the list of valid e-mails, and enters encycopedia.com, the system will prompt the sender with the presumed correct domain name (i.e., encyclopedia.com).

For one embodiment, the domain name of an address is compared to the domain names of other addresses on the same e-mail message. Where the addresses on the same e-mail message are not the same, but have a high correlation, they are indicated as suspect. A sender may typically send the same message to more than one recipient at the same organization. When that is the case it may be possible to detect a misspelled domain name by comparison to a correctly spelled domain name on the same e-mail message. For example, a sender may address an e-mail message to john@anyname.com, samir@anynane.com, and jose@anyname.com. In such a case it is quite likely that samir@anynane.com is a misspelling for samir@anyname.com.

For one embodiment, the domain name portion of the address is compared with both a list of frequently used domain names and the other domain name portion of each other address on the same e-mail.

The ability to detect misspelled domain names is particularly important because, unlike misspelled domain name-type extensions, misspelled domain names are frequently valid domain names. As more and more domain names come into use it will be more likely that a misspelling of a domain name is a valid domain name. Embodiments of the invention can be used to help prevent a misspelled domain from resulting in an e-mail message being sent to an unintended recipient.

For one embodiment, the user name portion of an address is evaluated. Usernames vary to a great extent even within the same organization and even for a given person so it may not be possible to store a list of commonly used usernames. However, user names have common characteristics that may be used to help determine erroneous user names. There are many characters that are typically excluded from user names. If a user name contains one or more of these characters, it may be assumed to be a misspelled user name.

For one embodiment, the address as a whole is evaluated against a list of commonly used addresses. Where there is no match, but a high correlation between the input address and an address on a list of frequently used addresses, the input address is suspect.

Embodiments of the invention are applicable to verifying that an input address is correct in circumstances other than addressing an e-mail message. For example, a user of a particular application may be requested to enter an e-mail address (e.g., their own) electronically in any number of circumstances (e.g., conducting business on-line). In such cases, the user's effort in filling out a lengthy form may be wasted if an incorrect e-mail address is entered. By comparing one or more portions of the entered e-mail address as discussed above, it may be possible to avoid inputting erroneous e-mail addresses in such circumstances.

As discussed above, when sending an e-mail, comparison of the user name may not be as helpful as comparing the domain name and domain name-type extension. At the receiving end, comparison of the user name may be very helpful in communicating the e-mail message to the intended recipient. For one embodiment of the invention, a receiving mail server receives an e-mail message. In this case, the domain name and domain name-type extension were valid (if not correct), or else the e-mail would not have made it as far as the receiving mail server. As noted above, in the prior art systems, the receiving mail server will bounce back a message that does not have a valid user name. In such cases when an e-mail is bounced to the sender after it has already been received by the receiving mail server (soft bounce) the sender will receive the non-delivery message after some period of time. Some mail servers will accept all incoming e-mails for later analysis without initially checking if the user name is valid. This means a sender may not get a non-delivery message for quite some time.

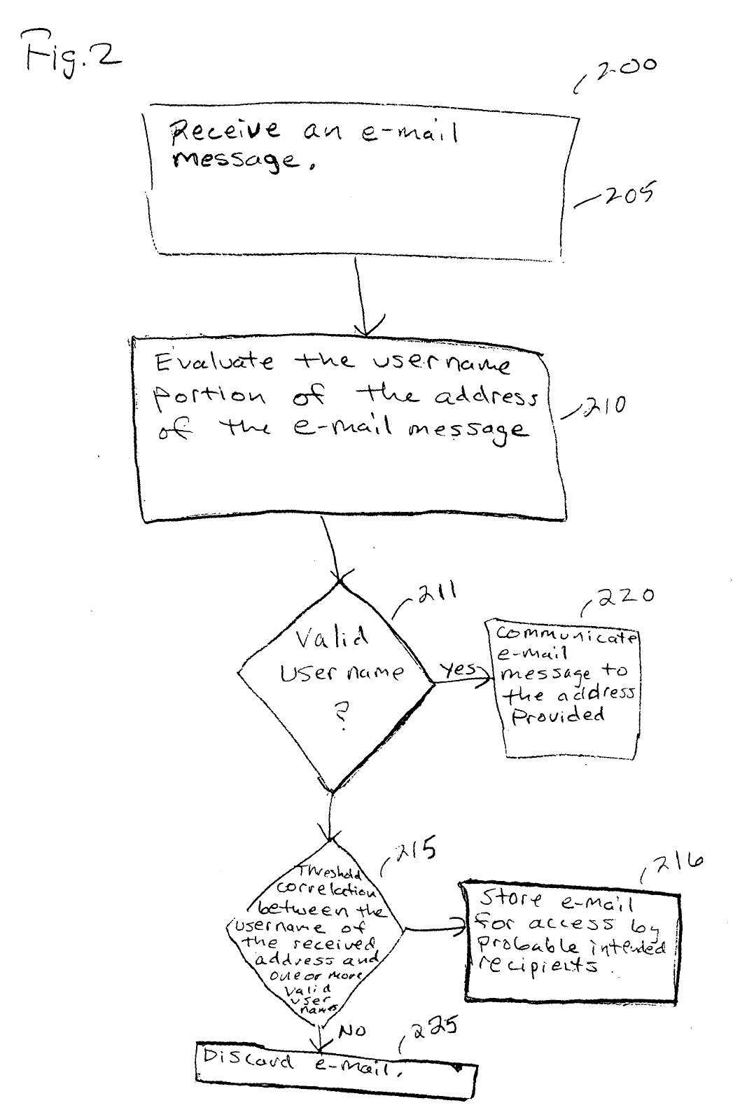

FIG. 2 is a process flow diagram illustrating a process in which an address is evaluated in accordance with one embodiment of the present invention. Process 200, shown in FIG. 2 begins at operation 205 in which an e-mail message is received by a receiving mail server.

At operation 210 the username portion of the address of the received e-mail (received user name) is evaluated.

At operation 211 a determination is made as to whether the received user name is valid. If the received user name is valid, the e-mail message is communicated to the address provided.

If, at operation 211, it is determined that the received user name is not valid, then, at operation 215, the received user name is further evaluated to determine if there is a threshold correlation between the received user name and one or more valid user names. For one embodiment, a failed delivery message is forwarded to the sender upon this determination.

If at operation 215 it is determined that there is a threshold correlation between the received user name and one or more valid user names, then the received e-mail message is stored for access by probable intended recipients at operation 216.

If at operation 215 it is determined that there is not a threshold correlation between the received user name and one or more valid user names, then the received e-mail message is discarded at operation 225.

The correlation between the received user name and valid user names may be determined through many well-known methods. Such methods may include a text comparison routine. For one embodiment, an audio signature of the received user name is created and compared to a stored audio signature of every valid user name. In such a scheme a correlation between valid user names and common misspellings of such names may be more readily apparent. For example, a misspelling of the user name “Phillip” as “Filup” may not meet a threshold correlation level for a text comparison scheme, but will show high correlation for an audio signature comparison scheme. Such a system may help to detect common misspellings based on phonetics.

Once the e-mail has been stored, the potential recipient having a user name with a high correlation to the received user name can be notified that an e-mail, probably intended for her has been received. Such a potential recipient may be notified of the time the e-mail was sent and received, the name and organization of the sender, as well as other identifying information to help the potential recipient determine if the e-mail was intended for her. Such information can be useful where more than one potential recipient has a user name having high correlation to the received user name.

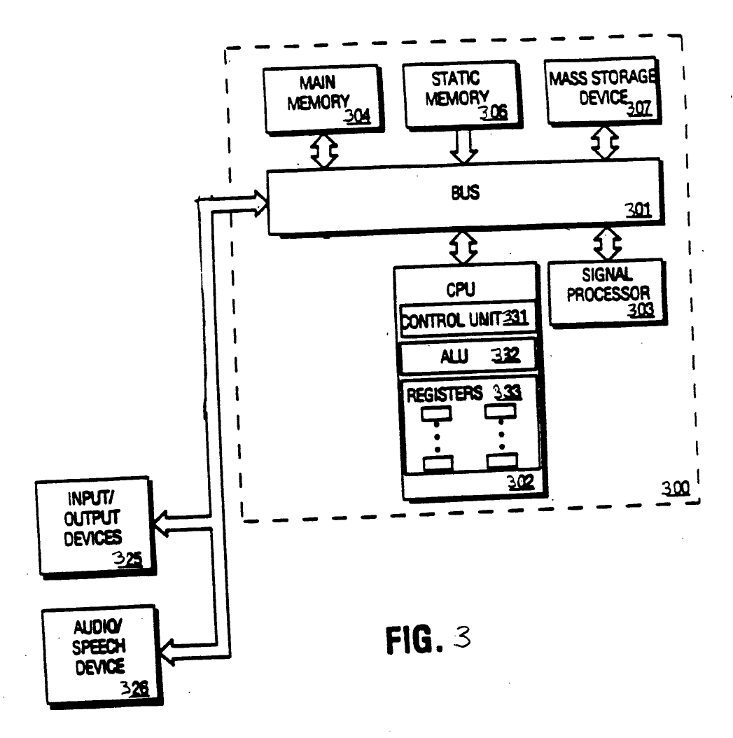

FIG. 3 is a block diagram illustrating one embodiment of a processing system 300 that may be used to send and receive e-mail messages in accordance with an embodiment of the present invention. For alternative embodiments of the present invention, processing system 300 may be a personal, or portable computer.

The components of processing system 300 are exemplary in which one or more components may be omitted or added. For example, one or more memory devices may be utilized for processing system 300.

Referring to FIG. 3, processing system 300 includes a central processing unit 302 and a signal processor 303 coupled to a main memory 304, static memory 306, and mass storage device 307 via bus 301. Processing system 300 may also be coupled to input/output (1/0) devices 325, and audio/speech device 326 via bus 301. Bus 301 is a standard system bus for communicating information and signals. CPU 302 and signal processor 303 are processing units for processing system 300. CPU 302 or signal processor 303 or both may be used to process information and/or signals for processing system 300. CPU 302 includes a control unit 331, an arithmetic logic unit (ALU) 332, and several registers 333, which are used to process information and signals. Signal processor 303 may also include similar components as CPU 302.

Main memory 304 may be, e.g., a random access memory (RAM) or some other dynamic storage device, for storing information or instructions (program code), which are used by CPU 302 or signal processor 303 to compose and communicate e-mail messages. Main memory 304 may store temporary variables or other intermediate information during execution of instructions by CPU 302 or signal processor 303. Static memory 306, may be, e.g., a read only memory (ROM) and/or other static storage devices, for storing information or instructions, which may also be used by CPU 302 or signal processor 303. Mass storage device 307 may be, e.g., a hard or floppy disk drive or optical disk drive, for storing information or instructions for processing system 300.

An e-mail message address portion evaluation function in accordance with the present invention can be implemented by hardware and/or software contained within computing system 300. For example, CPU 302 or signal processor 303 can execute code or instructions stored in a machine-readable medium, e.g., main memory 304. For various embodiments of the invention, the memory 306 or mass storage device 307 may be used to store valid address portions, valid addresses, or some representation of thereof. The memory 306 may be used to store the instructions to effect the comparison of input address portions or combinations thereof with corresponding valid address portions or combinations thereof.

The invention includes various operations. The operations of the invention may be performed by hardware components or may be embodied in machine-executable instructions, which may be used to cause a general-purpose or special-purpose processor or logic circuits programmed with the instructions to perform the operations.

Alternatively, the steps may be performed by a combination of hardware and software. The invention may be provided as a computer program product that may include a machine-readable medium having stored thereon instructions, which may be used to program a computer (or other electronic devices) to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication cell (e.g., a modem or network connection). All operations may be performed at the same central cite or, alternatively, one or more operations may be performed elsewhere.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

1. A method comprising:
receiving an e-mail address from a user as input to a processing system, the e-mail address having one or more address portions;
evaluating one or more of the address portions at the processing system;
determining the e-mail address is invalid if one or more of the evaluated address portions does not meet specified criteria; and
providing an indication of invalidity to the user, the indication indicating the one or more evaluated address portions that do not meet the specified criteria.

2. The method of claim 1 wherein evaluating one or more of the address portions includes comparing one or more of the address portions to a set of one or more corresponding valid address portions and the specified criteria include matching a corresponding valid address portion.

3. The method of claim 2 further comprising:
providing one or more valid address portions to the user based upon an address portion received from the user.

4. The method of claim 1 wherein the e-mail address is associated with an e-mail message.

5. The method of claim 1 wherein the one or more address portions are selected from the group consisting of user name, domain name, and domain name type.

6. The method of claim 1 further comprising:
receiving a corrected e-mail address from the user.

7. A machine-readable medium containing executable instructions which when executed by a digital process system cause the system to perform a method comprising: receiving an e-mail address from a user as input to a processing system, the e-mail address having one or more address portions;
evaluating one or more of the address portions at the processing system;
determining the e-mail address is invalid if one or more of the evaluated address portions does not meet specified criteria; and
providing an indication of invalidity to the user, the indication indicating the one or more evaluated address portions that do not meet the specified criteria.

8. The machine-readable medium of claim 7 wherein evaluating one or more of the address portions includes comparing one or more of the address portions to a set of one or more corresponding valid address portions and the specified criteria include matching a corresponding valid address portion.

9. The machine-readable medium of claim 8 further comprising:
providing one or more valid address portions to the user based upon an address portion received from the user.

10. The machine-readable medium of claim 7 wherein the e-mail address is associated with an e-mail message.

11. The machine-readable medium of claim 7 wherein the one or more address portions are selected from the group consisting of user name, domain name, and domain name type.

12. The machine-readable medium of claim 7 further comprising:
receiving a corrected e-mail address from the user.

13. A method comprising:
receiving an e-mail message at a receiving mail server, the e-mail message having an associated e-mail address, the e-mail address including a user name portion;
evaluating the e-mail address to determine that the e-mail address is not a valid e-mail address;
determining if a threshold level of correlation exists between the user name portion of the e-mail address at least one of a set of one or more valid user name portions; and
storing the e-mail message if the threshold level of correlation exists.

14. The method of claim 13 further comprising:
notifying one or more users of the associated e-mail address, each of the one or more users associated with one of the at least one valid user name portions.

15. The method of claim 13 wherein the level of correlation between the user name portion of the e-mail address at least one of a set of one or more valid user name portions is determined through use of a text comparison routine.

16. The method of claim 13 wherein the level of correlation between the user name portion of the e-mail address at least one of a set of one or more valid user name portions is determined by comparing an audio signature of the user name portion of the e-mail address with an audio signature of the at least one valid user name portions.

17. The method of claim 14 wherein notifying the one or more users of the associated e-mail address includes notifying the one or more users of the time the e-mail message was received and an e-mail address associated with a sender of the e-mail message.
